(19) United States
(12) Patent Application Publication
(10) Pub. No.: US 2010/0145964 A1
(43) Pub. Date: Jun. 10, 2010

(54) SYSTEM FOR PROVIDING IDENTIFIERS FOR USE IN CONNECTION WITH A CATALOG OF PRODUCTS

(75) Inventor: Geoffry A. Westphal, Park Ridge, IL (US)

Correspondence Address: GREENBERG TRAURIG, LLP, 77 WEST WACKER DRIVE, SUITE 3100, CHICAGO, IL, 60601-1732, US

(73) Assignee: W.W. Grainger, INC., Lake Forest, IL (US)

(21) Appl. No.: 12/330,634

(22) Filed: Dec. 9, 2008

(51) Int. Cl. G06F 17/30

(52) U.S. Cl. 707/758; 707/E17.014

(57) ABSTRACT

A system for providing identifiers for use in connection with a catalog of products functions by providing an identifier as a query term to a search engine associated with an Internet server. The results obtained from the Internet server as a result of providing the identifier as the search engine query term are parsed to discern a number of search hits included within the results. If the number of search hits included within the results is within a predefined threshold, the identifier is selected to be used in a catalog to indentify one or more products listed within the catalog of products.

### BACKGROUND

The following relates generally to e-commerce systems and, more particularly, relates to a system for providing identifiers for use in connection with a catalog of items and/or services, collectively referred to as “products” hereinafter.

Systems and methods for automating the production of sales catalogs, in particular, to assign a unique catalog number for particular items that are to be included in a sales catalog are known in the art. For example, U.S. Pat. No. 5,231,566 discloses a system for producing a catalog of items wherein a computer system is used to assign a catalog item number to the items that are to be listed in the catalog such that each unique item contains a unique catalog item number. Specifically, a cataloging software program is executed by the computer and functions to determine whether an inputted item has previously been assigned a catalog item number by comparing information relevant to the inputted item, such as a UPC code, brand name, product name, product description, and size, against similar information that is maintained for a plurality of items in a master item list. In this manner, if the information relevant to the inputted item does not correspond to any of the information relevant to the plurality of items in the master item list, a new catalog item number is generated and assigned to the inputted item and, if the information relevant to the inputted item does correspond to information relevant to one of the plurality of items in the master item list, the cataloging system determines that the inputted item already exists in the master item list and the catalog item number assigned to the item in the master list having the corresponding information is also assigned to the inputted item. Accordingly, upon completion of the processing all like items will have the same catalog item number whereas different items will have different catalog item numbers.

### SUMMARY

The following describes an improved system for providing identifiers for use in connection with a catalog of products. Specifically, the system functions by providing an identifier as a query term to a search engine associated with an Internet server. The results obtained from the Internet server as a result of providing the identifier as the search engine query term are examined, i.e., parsed, to discern a number of search hits included within the results. If the number of search hits included within the results is within a predefined threshold, the identifier is selected to be used in a catalog to indentify one or more products listed within the catalog of products.

A better understanding of the objects, advantages, features, properties and relationships of the system and method described hereinafter will be obtained from the following detailed description and accompanying drawings which set forth illustrative embodiments which are indicative of the various ways in which the principles of the invention may be employed.

### BRIEF DESCRIPTION OF THE DRAWINGS

For a better understanding of the described system for providing identifiers for use in connection with a catalog of products, reference may be had to preferred embodiments shown in the following drawings in which:

FIG. 1 is a block diagram illustrating an exemplary computer system in which the principles of the described invention may be employed; and

FIG. 2 is a flow chart diagram illustrating exemplary steps for providing identifiers for use in connection with a catalog of products.

### DETAILED DESCRIPTION

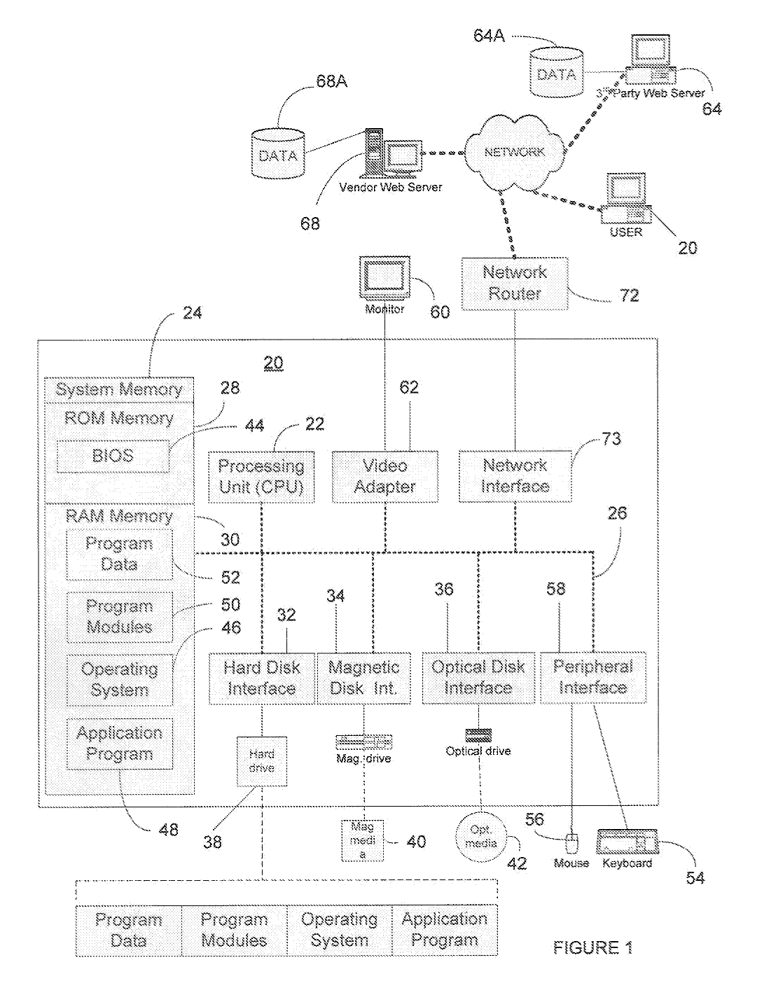

Turning to the drawings, wherein like reference numerals refer to like elements, an exemplary system for providing identifiers for use in connection with a catalog of products is described. In particular, as illustrated in FIG. 1, the system will be described in the context of a plurality of processing devices linked via a network, such as the World Wide Web or the Internet. In this regard, a processing device 20, illustrated in the exemplary form of a computer system, is provided with executable instructions to, for example, provide a means for a user to access a vendor server 68 and thereby perform a search for items. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those skilled in the art will also appreciate that the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. By way of further example, the bus 26 may include an architecture having a North Bridge and a South Bridge where the North Bridge acts as the connection point for the processing unit 22, memory 24, and the South Bridge. The North Bridge functions to route traffic from these interfaces, and arbitrates and controls access to the memory subsystem from the processing unit 22 and I/O devices. The South Bridge, in its simplest form, integrates various I/O controllers, provides interfaces to peripheral devices and buses, and transfers data to/from the North bridge through either a PCI bus connection in older designs, or a proprietary interconnect in newer chipsets.

As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example, via a network connection.

An end-user may enter commands and information into the processing device 20 through input devices such as a keyboard 54 and/or a pointing device 56. While not illustrated, other input devices may include a microphone, a joystick, a game pad, a scanner, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

The processing device 20 may also utilize logical connections to one or more remote processing devices, such as a Web servers 64, 68 having associated data repositories. In this regard, while the remote processing devices 64, 68 have been illustrated in the exemplary form of a computer, it will be appreciated that the remote processing devices 64, 68 may be any type of device having processing capabilities. Again, it will be appreciated that the remote processing devices 64, 68 need not be implemented as a single device but may be implemented in a manner such that the tasks performed by the remote processing devices 64, 68 are distributed to a plurality of processing devices linked through a communication network

For performing tasks as needed, the remote processing devices 64, 68 may include many or all of the elements described above relative to the processing device 20. By way of further example, the remote processing device 68 may include the executable instructions for handling search requests and providing search results with the processing device 20 being a thin client or a simple input/output device. Communications between the processing device 20 and the remote processing device 64 may be exchanged via a further processing device, such a network router 72, that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of the remote processing device 64.

In the field of catalogs, vendors often include a number, such as an ordering number, stock keeping unit number, manufacturer's model number, etc., for each product. As will be appreciated, the product number is helpful in identifying a product such as when filling out order forms, telephoning in an order to a vendor, ordering online, etc. In addition, a product number is often used in connection with on-line searches when a consumer attempts to find information concerning a particular product. However, with thousands of companies selling millions of products, it is seen that very few of these manufacturing and ordering model numbers are unique. That is to say, searching on-line for a particular model number often results in many search results being returned by a search engine. For example, a search for a model number 03289 on Yahoo currently yields more than 214,000 pages of search results including hotels in ZIP code 03289, audio cables, an automotive tool set, and a candelabra light bulb. Thus, if 03289 is a product number on the bottom of a large-display calculator a customer wishes to purchase, a customer searching for and desiring to order this product will have a difficult time navigating the aforementioned search results to find a link that will direct the customer to a company that sells the desired calculator. As will be further appreciated, this difficulty manifests in lost sales.

To provide the identifiers for use in connection with a catalog of products, including print catalogs as well as on-line catalogs, e.g., an on-line catalog hosted by vendor 68, the subject system uses search results obtained from a third party Web server 64 such as a Web server hosted by Google, Yahoo, and the like. More particularly, the subject invention seeks to uncover search terms that, when provided to an on-line search engine associated with one or more third party Web servers 64, yield no or only a few results. Those search terms that yield no or only a few results when provided to a search engine of a third party Web server 64 are then preferably selected, for example, to be used in connection with a table, catalog page, or the like which, in turn, identifies multiple products. While a search term that yields no or only a few results when provided to a search engine of a third party Web server 64 may be used in connection with identifying a single product, it will be understood that it is unlikely that a vendor will want to reissue new model numbers for a product that is currently being sold. Thus, the main emphasis of this invention focuses on providing a label or identifier that incorporates a search terms that yields no or only a few results to a catalog table, page, or the like (individually and collectively referred to as “catalog table”) having a grouping of logically related products, e.g., products have the same intended use, are of the same genre, are of the same type, are of the same manufacturer, are to be used in connection with the repair of an item, are to be used together, etc.

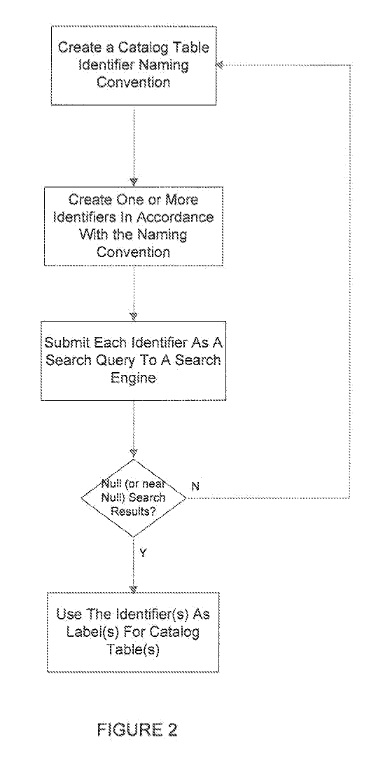

To choose an identifier that will be used in connection with a catalog table label, search terms are provided to the search engine of a third party Web server 64, such as illustrated in FIG. 2. The search terms can be numeric, alphabetic, or alphanumeric. The search terms can be sequential, near sequential, or random. The search terms may also share the same length or may be of different lengths. Accordingly, any form of naming convention maybe adopted.

Once a naming convention has been settled upon, one or more catalog table identifiers created in accordance with the naming convention are fed, using a manual or automated batch process, into any of the popular internet search engines hosted on various third party servers 64. If an identifier or group of identifiers provided in accordance with the naming convention yields zero or very few search engine results, as determined manually or by means of a computer-implemented search result analysis tool, then the identifier or identifiers created in accordance with the naming convention can be considered as fitting the requirements as described above. For example, an identifier returning null search results may be pre-pended to one or more existing catalog table names, each identifier in a group of identifiers returning null search results may be used to label a respective catalog table, etc. It will also be appreciated that, even if a null search result is obtained, different naming conventions can be tried to minimize the length of an identifier.

As will therefore be appreciated, because a product number selected in this manner can end up in thousands of documents found on the internet, including blogs, discussion groups, and communities, as a result of being included in marketing materials, fliers, and catalogs which typically end up in the indexes of internet search engines, when a user searches using a catalog table identifier selected in the manner above-described a search engine will yield a unique result that will allow the customer to be easily directed to the vendor 68 of the corresponding product or other information that is highly likely to be relevant. In this way, a vendor's good customer experience can begin on the otherwise public internet.

While specific embodiments of the invention have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

What is claimed is:

1. A method for providing identifiers for use in connection with a catalog of products, comprising:
providing an identifier as a query term to search engine associated with an Internet server;
parsing the results obtained from the Internet server as a result of providing the identifier as the search engine query term to discern a number of search hits included within the results; and
if the number of search hits included within the results is within a predefined threshold, using the identifier in a catalog to indentify one or more products listed within the catalog of products.

2. The method as recited in claim 1, wherein the catalog comprises a print catalog.

3. The method as recited in claim 1, wherein the catalog comprises an electronic catalog.

4. The method as recited in claim 1, wherein the identifier is associated with a catalog table that includes products that are logically related.

5. The method as recited in claim 4, wherein the catalog table comprises a page pre-existing in a multi-page catalog.

6. A computer-readable media having embedded computer-executable instructions for providing identifiers for use in connection with a catalog of products, the instructions performing steps comprising:
providing an identifier as a query term to search engine associated with an Internet server;
parsing the results obtained from the Internet server as a result of providing the identifier as the search engine query term to discern a number of search hits included within the results; and
if the number of search hits included within the results is within a predefined threshold, selecting the identifier as a candidate for use in a catalog to indentify one or more products listed within the catalog of products.

7. The computer-readable media as recited in claim 6, wherein the catalog comprises a print catalog.

8. The computer-readable media as recited in claim 6, wherein the catalog comprises an electronic catalog.

9. The computer-readable media as recited in claim 6, wherein the identifier is to be associated with a catalog table that includes products that are logically related.

10. The computer-readable media as recited in claim 9, wherein the catalog table comprises a page pre-existing in a multi-page catalog.
